(19) United States
(12) Patent Application Publication
(10) Pub. No.: US 2018/0031196 A1
(43) Pub. Date: Feb. 1, 2018

(54) ILLUMINATION DEVICE, METHOD AND SYSTEM

(71) Applicant: Jaguar Land Rover Limited, Coventry, Warwickshire (GB)

(72) Inventors: Gary CRIPPS, Coventry, Warwickshire (GB); Nicholas RIDLER, Coventry, Warwickshire (GB); David WITHEY, Coventry, Warwickshire (GB)

(21) Appl. No.: 15/552,765

(22) PCT Filed: Feb. 18, 2016
(86) PCT No.: PCT/EP2016/053428

§ 371 Date: Aug. 22, 2017

(30) Foreign Application Priority Data
Feb. 23, 2015 (GB) 1502975.4

(51) Int. Cl. F21S 8/10; F21K 9/64; F21V 29/77

(52) U.S. Cl. CPC F21S 48/1225; F21V 29/77; F21S 48/328; F21S 48/1145; F21S 48/1747; F21K 9/64; F21S 48/31; F21S 48/125; F21S 48/171; F21Y 2115/30

(57) ABSTRACT

The present disclosure relates to an illumination device (10) for use as a vehicle headlight, comprising: at least one excitation means (12) for emitting excitation light; and a fluorescing means (14) for receiving at least a portion of the excitation light and emitting illuminating light in response thereto in an illumination direction of the illumination device (10). The at least one excitation means (12) is arranged substantially perpendicular to, or forward of, the fluorescing means (14) in the illumination direction to emit excitation light toward the fluorescing means (14). The present disclosure also relates to an illumination system comprising aforesaid illumination device, a method of providing illumination or illuminating light for use as a vehicle headlight, and to a vehicle.

### TECHNICAL FIELD

The present disclosure relates to an illumination device, method and system and particularly, but not exclusively, to a lighting apparatus for use in a vehicle headlight. Aspects of the invention relate to an illumination system, an illumination device for use as a vehicle headlight, a method for providing illumination or illuminating light for use as a vehicle headlight, and to a vehicle.

### BACKGROUND

Illumination devices for use in vehicle headlights may include an excitation light source provided in combination with a fluorescent substance. These devices are configured such that the excitation light source irradiates the fluorescent substance with excitation light. The fluorescent substance absorbs at least a portion of received excitation light and emits illuminating light in response thereto. The illumining light may then be projected forward from the illumination device to illuminate an area in front of the vehicle. However, the excitation light may have high coherence which makes it potentially hazardous as exposure of such light to parts of the human eye can permanently damage a person's sight. Therefore, it is of great importance that the excitation light is contained within the illumination device.

Additionally, illumination devices for use in vehicle headlights may be required to project different spatial light distributions. For example, vehicle headlights are typically required to project a low beam distribution and a high beam distribution. While high beam distributions generally cast illuminating light straight ahead of the vehicle, low beam distributions generally limit the height to which light is cast to prevent dazzling road users. Low beam distributions also typically cast light sideward, such as rightward (in right-hand traffic countries) or leftward (in left-hand traffic countries).

It is an object of certain embodiments of the invention to prevent potentially dangerous excitation light from leaking from an illumination device for use in a vehicle headlight.

Furthermore, it is an object of certain embodiments of the invention to control the distribution of the light projected by an illumination device for use in a vehicle headlight. It is an object of embodiments of the invention to at least mitigate one or more of the problems of the prior art.

### SUMMARY OF THE INVENTION

Aspects and embodiments of the invention provide an illumination device for use as a vehicle headlight, an illumination system optionally comprising aforesaid illumination device, a method of providing illumination or illuminating light for use as a vehicle headlight, and to a vehicle as claimed in the appended claims.

According to an aspect of the invention, there is provided an illumination device for use as a vehicle headlight. The device may comprise at least one excitation means for emitting excitation light. The device may comprise a fluorescing means for receiving at least a portion of the excitation light and emitting illuminating light in response thereto in an illumination direction of the illumination device. The device, when used as a vehicle headlight, may provide a lower rate of power consumption when compared to that of a conventional vehicle headlight.

According to another aspect of the invention, there is provided an illumination device, comprising the illumination device of the abovementioned aspect, wherein the at least one excitation means is arranged substantially perpendicular to, or forward of, the fluorescing means in the illumination direction to emit excitation light toward the fluorescing means. This arrangement may prevent excitation light from being emitted from the device in the illumination direction.

An illumination device of the either of the above aspects, wherein: said means for emitting excitation light comprises an excitation light source; and said means for receiving at least a portion of the excitation light and emitting illuminating light in response thereto comprises a fluorescent material.

Optionally, the at least one excitation means may be provided as a radial array of two or more excitation means which are arranged to direct emitted excitation light radially inward toward the fluorescing means.

In some embodiments, the illuminating light is emitted in the illumination direction through a central region of the radial array. In some embodiments, the illumination device further comprises a housing arranged to support the at least one excitation means in relation to the fluorescing means. Further, the housing may comprise an opening though which the illuminating light is directed, in use, in the illumination direction.

Optionally, the housing may comprise an annular portion, wherein the radial array of two or more excitation means may be arranged around the annular portion.

In some embodiments, the two or more excitation means are generally equally spaced around the annular portion. The opening may be provided as a central region of the annular portion. Further, the at least one excitation means may be arranged to emit the excitation light in a direction at least partly opposed to the illumination direction.

The at least one excitation means may be arranged forward of the fluorescing means in the illumination direction at an angle within a range of 5 to 85° relative to the illumination direction. In some embodiments, the housing may form a channel having front and rear openings. Optionally, an axis of the channel substantially corresponds to the illumination direction.

In some embodiments, the illuminating light is directed, in use, toward the front opening of the housing. In some embodiments at least one projecting means is arranged at a front opening of the housing. Optionally, the projecting means may be provided as a lens. In some embodiments the illumination device further comprises a reflecting means attached to the rear opening of the housing. Optionally, the reflecting means may be provided as a casing.

Optionally, the fluorescing means may be arranged generally within the reflecting means. Further, the illumination device may also comprise a reflecting surface arranged to a rear of the fluorescing means for directing illuminating light in the illumination direction. The reflecting surface may be arranged upon an interior surface of the reflecting means.

In some embodiments, the housing may be generally cylindrical and the front and rear openings may be arranged to respective ends of the housing.

Optionally, the at least one excitation means may be arranged to irradiate one or more predetermined regions of the fluorescing means with the excitation light.

Optionally, the housing may be arranged to provide a thermal conduit for the at least one excitation means. The housing may form a heat sink for the at least one excitation means. The housing may comprise a plurality of heat dissipating fins. The housing may comprise a plurality of sockets, wherein each excitation means may be received in a respective socket.

According to a further aspect of the invention, there is provided a method of providing illuminating light for use as a vehicle headlight, comprising: emitting excitation light from at least one excitation means toward a fluorescing means where the excitation means is arranged substantially perpendicular to, or forward of, the fluorescing means; and emitting, by the fluorescing means, illuminating light in an illumination direction of the illumination device. The method may prevent excitation light from being emitted from the device in the illumination direction.

The method of providing illuminating light of the above aspect, wherein: said means for emitting excitation light comprises an excitation light source; and said means for receiving at least a portion of the excitation light and emitting illuminating light in response thereto comprises a fluorescent material.

According to yet another aspect of the invention, there is provided an illumination device for use as a vehicle headlight, comprising: a plurality of excitation means for emitting excitation light; and a fluorescing means for receiving at least a portion of the excitation light emitted by the excitation means and emitting illuminating light in response thereto; wherein the plurality of excitation means are spaced around the fluorescing means and each light source is independently operable to control a distribution of illuminating light emitted by the fluorescing means. The plurality of excitation means are independently operable to control a distribution of light emitted by the florescence material so as to permit the alteration of the spatial distribution of illuminating light.

An illumination device of the above aspect, wherein: said means for emitting excitation light comprises an excitation light source; and said means for receiving at least a portion of the excitation light and emitting illuminating light in response thereto comprises a fluorescent material.

Optionally, each of the plurality of excitation means may be arranged to irradiate a respective region of the fluorescing means with the excitation light to thereby control the distribution of illuminating light. The at least one excitation means may be provided as a radial array of two or more excitation means which may be arranged to direct emitted excitation light radially inward toward the fluorescing means.

In some embodiments, the illuminating light is emitted in the illumination direction through a central region of the radial array.

According to yet another aspect of the invention, there is provided an illumination system, comprising: an illumination device of the aforementioned aspects; and a control means arranged to selectively cause at least some of the plurality of excitation means to emit excitation light toward the fluorescing means.

An illumination system of the above aspect, wherein said means arranged to selectively cause at least some of the plurality of excitation means to emit excitation light toward the fluorescing means comprises a control unit.

In some embodiments, the control means may be arranged to: selectively cause a first group of the excitation means to emit excitation light to form a first distribution of illuminating light; and selectively cause a second group of the excitation means to emit excitation light to form a second distribution of illuminating light. The first and second distributions may be different spatial distributions of illuminating light.

Optionally, the first distribution of illuminating light may be a dipped-beam pattern and the second distribution may be a full-beam pattern. The first distribution of illuminating light may be for use on a left-hand driving roadway pattern and the second distribution may be for use on a right-hand driving roadway.

In some embodiments, the first group of the excitation means and the second group of the excitation means may comprise at least some common excitation means.

According to a yet a further aspect of the invention, there is provided method of providing illumination for use as a vehicle headlight, comprising: selectively causing one or more of a plurality of excitation means spaced around a fluorescing means to emit excitation light toward the fluorescing means, wherein the fluorescing means is arranged for receiving at least a portion of the excitation light emitted by the excitation means and emitting illuminating light in response thereto and the one or more of the plurality of excitation means are selected to control a distribution of illuminating light emitted by the fluorescing means. The plurality of excitation means are independently operable to control a distribution of light emitted by the florescence material so as to permit the alteration of the spatial distribution of illuminating light.

An illumination device of the above aspect, wherein: said means for emitting excitation light comprises an excitation light source; and said means for receiving at least a portion of the excitation light and emitting illuminating light in response thereto comprises a fluorescent material.

Optionally, the method of the aspect may further comprise: selectively causing a first group of the plurality excitation means to emit excitation light to form a first distribution of illuminating light; and selectively causing a second group of the plurality excitation means to emit excitation light to form a second distribution of illuminating light. The first and second distributions may be different spatial distributions of illuminating light.

In some embodiments, the first distribution of illuminating light may be a dipped-beam pattern and the second distribution may be a full-beam pattern. The first distribution of illuminating light may be for use on a left-hand driving roadway pattern and the second distribution may be for use on a right-hand driving roadway.

According to another aspect of the invention, there is provided a vehicle comprising an illumination device or an illumination system of the abovementioned aspects.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

Embodiments of the invention will now be described by way of example only, with reference to the accompanying figures, in which:

FIG. 1 illustrates a perspective view of an embodiment of an illumination device according to an embodiment of the invention;

FIG. 2 illustrates a partial cross sectional side view of the illumination device of FIG. 1;

FIGS. 3a and 3b illustrate diagrams of possible spatial distributions of illuminating light which can be formed with the illumination device of FIG. 1 as viewed from the side of a vehicle; and

FIGS. 4a and 4b illustrate diagrams of further possible spatial distributions of illumination light which can be formed with the illumination device of FIG. 1 as viewed from above a vehicle.

### DETAILED DESCRIPTION

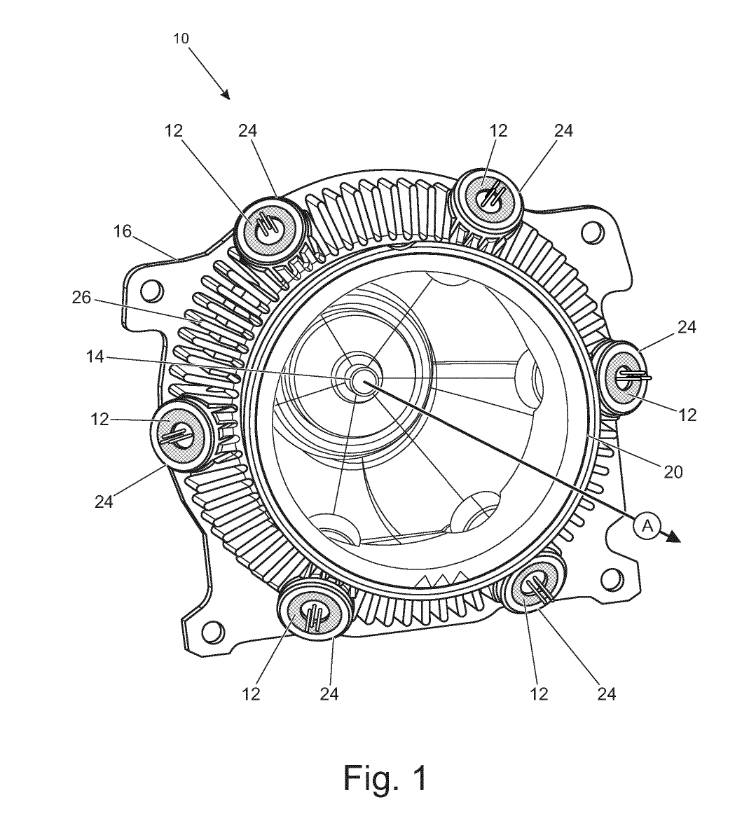

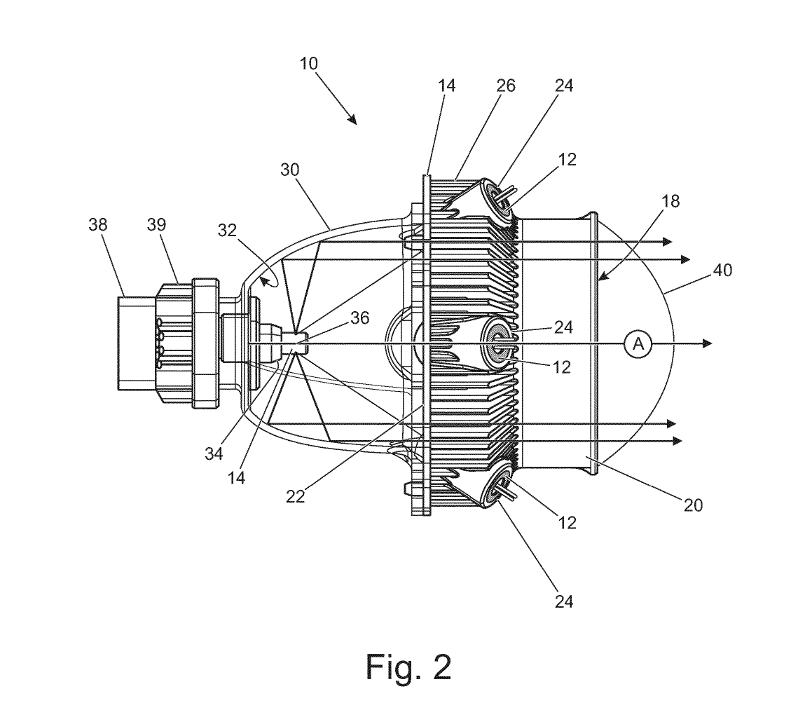

Referring to FIGS. 1 and 2 there is illustrated a device 10 according to an embodiment of the invention. The device 10 is an illumination device in the form of a vehicle headlight for illuminating an area in front of a vehicle. Although, it will be understood that the invention may be used in general lighting applications, such as domestic lights. Further, embodiments of the invention are not limited to use within specific types of vehicle and may be used, for example, in automobiles, cycles, motorcycles, marine craft and aircraft. The device 10 comprises an excitation means 12 for emitting excitation light and a fluorescing means 14 for receiving at least a portion of the excitation light and emitting illuminating light in response thereto. The device 10 may further comprise a reflecting means 30 for reflecting the illuminating light within the device 10 and a projecting means 40 for projecting the illuminating light from the device 10.

The excitation means may be provided as a plurality of laser modules 12 which may, in some embodiments, be arranged as a radial array of laser modules 12. It will be understood that in certain embodiments a single laser module 12 may be alternatively provided. In other embodiments the excitation means may also be provided in alternative forms, for example as one or more high-power light emitting diode (“LEDs”) or semi-conductor diodes.

The fluorescing means may be provided as at least one florescent block 14. The florescent block 14 may be formed from at least one fluorescent material, such as phosphor, which may be a silica based phosphor. The block 14 may also incorporate other materials, for example a diffusion material, such as alumina, for diffusing light received from the laser modules 12. Materials for improving thermal conductivity of the fluorescing means may also be incorporated therein, e.g. diamond powder. At least one binder material may also be incorporated in the florescent block 14, for example a polymeric resin, for binding multiple materials used to form the block 14. It will be understood that other or alternative materials may be included in the at least one florescent block 14. Further, the fluorescing means 14 may be provided in an alternative form, for example a surface covering or coating. The coating or covering may be applied to a component or a surface the illumination device 10.

The radial array of laser modules 12 may be spaced around a circumference of a substantially annular housing 16. In the embodiment shown in FIG. 1 the plurality of laser modules 12 are spaced equally around the housing 16. The housing 16 may define a circular channel 18 with front and rear openings 20, 22. Sockets 24 may be provided about the housing 16 to support and/or locate each of the laser modules 12. Each laser module 12 may be supported by the housing 16 to be inwardly angled such that light emitted from the respective laser module 12 is directed toward the florescent block 14. Furthermore, each of the sockets 24 may at least partially encapsulate the respective modules 12. Respective electrical connections on each of the modules 12 may be accessible on a front of the device 10.

The number of laser modules 12 is not material, while six are illustrated in the accompanying figures, the number of modules may be, for example, between one and ten. Furthermore, the spacing between each of the laser modules need not be equal and, in other embodiments, the spacing may vary about the circumference of the housing 16.

The housing 16 may be formed by casting, by machining or in any other convenient manner. While a one-piece cast housing is depicted in FIGS. 1 and 2, the housing 16 may be fabricated from multiple discrete components which are assembled in a suitable manner. The housing 16 may be formed of a material with high thermal conductivity, such as a metallic material, for example an aluminium alloy. It will be realised that other materials may be used. In use, the housing 16 may act as a heat sink to dissipate heat energy generated by the laser modules 12. Fins 26 may be provided to increase the surface area of housing 16 and thus maximise the cooling potential of the heat sink. The fins 26 may be arranged upon any surface of the housing, although in FIGS. 1 and 2 the fins 26 are arranged about the housing 16 or, more specifically, an outer surface thereof. The housing 16 may be formed using a cast aluminium or copper alloy. For example, a 7000 series aluminium alloy.

As mentioned above, the modules 12 may be configured to direct respective beams of collimated laser light radially inwardly toward the florescent block 14. At least a portion of the laser light emitted by the modules 12 may irradiate the block 14. In use, the block 14 absorbs at least a portion of the received excitation light and emits illuminating light. The illuminating light may be substantially white light. The laser diodes 12 in combination with the florescent block 14 may produce high-contrast white light within a range of colour temperatures, for example from 5500 to 6000 K. The rate of power consumption of each of the diodes 12 may be less than 10 W and may be, by way of example, between 1 and 5 W. Therefore, the power consumption of the device 10 may be significantly lower than that of a conventional vehicle headlight, for example a halogen headlight which may have a power consumption rate exceeding 120 W.

In certain embodiments, one or more collimating lenses (not shown) may also be provided to focus the beams of laser light on the block 14. The one or more collimating lenses may be arranged between the laser module 12 and the florescent block 14 to collimate laser light passing therethrough. Furthermore, the laser light may have a high level of directivity so that each of the laser modules 12 may be configured to irradiate only a respective predetermined region of the block 14.

The reflecting means may be provided as a rear casing 30. The casing 30 may be shaped like a dome or cupola. The casing 30 may be attached to the rear of the housing 16 such that it occludes the rear opening 22. The casing 30 may form a hollow body with a reflecting interior surface 32 whereby the surface 32 may at least partially surround the florescent block 14. The block 14 may be held inside the casing 30 by a support 34. The casing 30 may be formed from a metal with a high reflectivity, such as aluminium, thus inherently providing the reflecting surface 32. Alternatively, the reflecting surface 32 may be provided on at least a portion of the casing 30 by a reflective film attached to the interior surface 32. The film may be provided as a metal film, such as silver or aluminium. A film may be formed on the casing 30 in embodiments where the casing 30 is made from a non-metallic or non-reflective material. In certain other embodiments a separate reflecting element may be provided within the casing 30 and/or the hollow body of the housing 16.

The casing 30 and the reflecting surface 32 may be provided in the form of a parabolic mirror which has a focal point 36. The support 34 may position the florescent block 14 at the focal point 36 so that at least a portion of the illuminating light emitted by the block 14 is reflected at the reflecting surface 32 to form a generally collimated beam of illuminating light. The collimated beam may be directed along an axis of illumination A. A cooling fan 38 may be provided to dissipate heat generated by the phosphor block 14. The support 34 may provide a heat sink for the same purpose. A collet member 39 having a plurality of fins and arranged at the rear of the device 10 may provide a further heat sink.

The projecting means may be formed as at least one lens 40. The lens 40 may be attached to a front of the housing 16. The shape of the lens 40 may correspond to the shape of the opening 20 and may be attached to the housing 16 so as to occlude the front opening 20. When attached in this manner, the lens 40 prevents foreign object debris from entering the illumination device 10. The lens 40 has an optical axis which may coincide with the direction of illumination A. Illuminating light directed along the axis A travels in a forward direction, leaving the rear casing 30 to pass through the circular channel 18 and may be projected from the device 10 via the front opening 20 and lens 40. The lens 40 may be arranged to distribute the beam of collimated light in front of the vehicle. The lens 40 may configure the distribution of light to provide satisfactory illumination of the area in front of the vehicle.

As illustrated in FIGS. 1 and 2, the laser modules 12 may be arranged in front of the phosphor block 14 with respect to the direction of illumination A. In this configuration laser light is directed into the hollow body of the rear casing 30 and not in a direction toward the lens 40 in which it could be projected from the device 10. It is paramount that high coherence excitation light is not projected from the device 10, at least not in the forward direction. Exposure of the human eye to such light can result in damage to the retina, the cornea or other parts of the eye. At the very least, excitation light projected or leaked from the device 10, especially in the forward direction, could result in dazzling oncoming traffic.

Other means to reduce the risk of leakage of high coherence light may be incorporated in the device 10, such as filters or light scattering materials formed on the lens 40. However, if components of the device 10 were to become damaged or worn the excitation light may be projected from the device 10. The rear facing arrangement of the laser modules 12, as described above and illustrated in FIGS. 1 and 2, may help ensure safe operation of the device by directing laser light in a rear facing direction away from the front opening 20.

In the embodiment illustrated in FIGS. 1 and 2 laser light is directed rearwardly at angle of approximately 35° relative to the axis of illumination A. However, it is to be understood that the excitation light could be directed at an angle between 0 and 90° relative to the axis of illumination A.

The laser modules 12 may be independently operable, i.e. each of the modules 12 may be switched on and off independently of the others. Therefore, in use, only at least one predetermined region of the block 14 may be irradiated with laser light by selectively operating a subset of the laser modules 12. That is to say areas of the block 14 may be selectively irradiated by controlling the operation of the laser modules 12. Furthermore, the intensity of each of the modules 12 may be independently variable between a minimum intensity and a maximum intensity to selectively control the intensity of the irradiating laser light over each predetermined region. By independently operating a subset of the modules 12, or controlling a relative intensity of each of the modules 12, the distribution of illuminating light emitted by the block 14 may be manipulated. Consequently, multiple spatial distributions of the illuminating light protected from the device 10 may be formed. The spatial distributions are formed responsive to control of the laser modules 12.

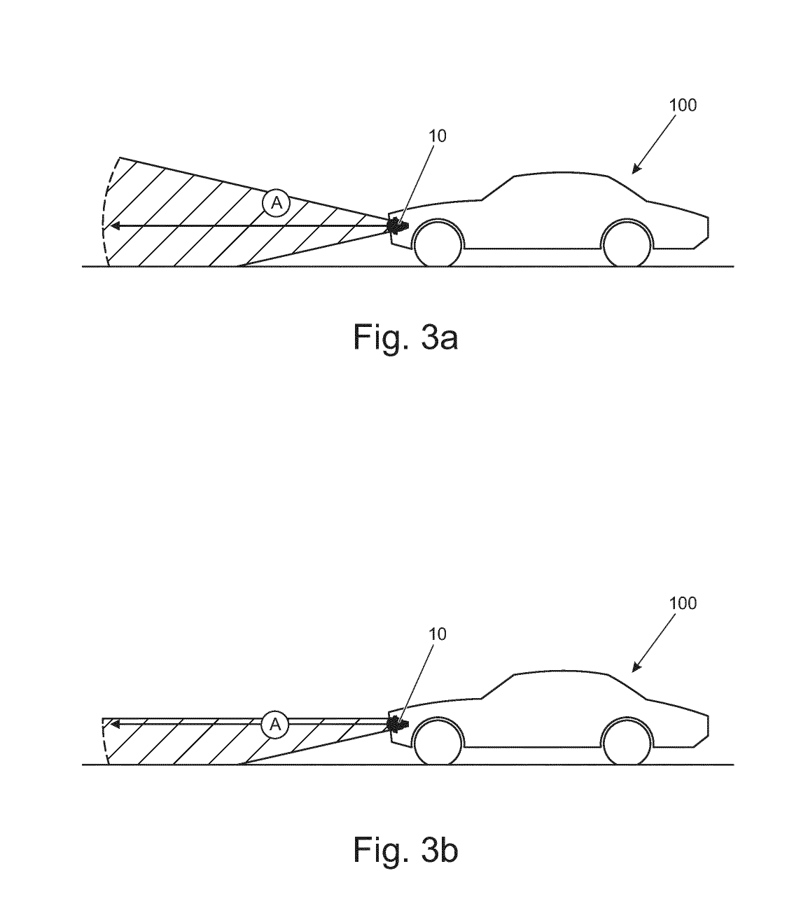

FIGS. 3a and 3b illustrate example variations in vertical spatial light distribution which may be projected from the illumination device 10. The device 10 may be integrated within a vehicle 100. Specifically, FIG. 3a illustrates a substantially wide angle vertical distribution of illuminating light cast in front of the vehicle 100. The vertical distribution in FIG. 3a may correspond to a high beam distribution. This distribution may be projected from the device 10, for example, by selectively operating all of the laser modules 12. Operating all of the modules 12 may irradiate substantially all of the block 14 evenly with laser light, thus the block may emit illuminating light radially in all directions. Of course, it will be understood that in some embodiments one or more wide angle vertical distributions and/or high beam distributions may be formed by selectively operating one or more subsets of the laser modules 12.

FIG. 3b illustrates a substantially narrow angle vertical distribution of illuminating light, at least narrower that the distribution illustrated in FIG. 3a. The vertical distribution in FIG. 3b may correspond to a low beam distribution wherein the height to which illuminating light is projected in front of the vehicle 100 is limited by operation of the device 10. This distribution may be projected from the device 10 by selectively operating a subset of the laser modules 12, for example the laser modules 12 on a lower portion of the device 10. Operating a subset of the modules 12 may irradiate one or more predetermined regions on a lower half of the block 14 with laser light, thus the block may emit illuminating light radially in a downward direction only. It will be understood that in some embodiments one or more narrow angle vertical distributions and/or low beam distributions may be formed by selectively operating one or more subsets of the laser modules 12.

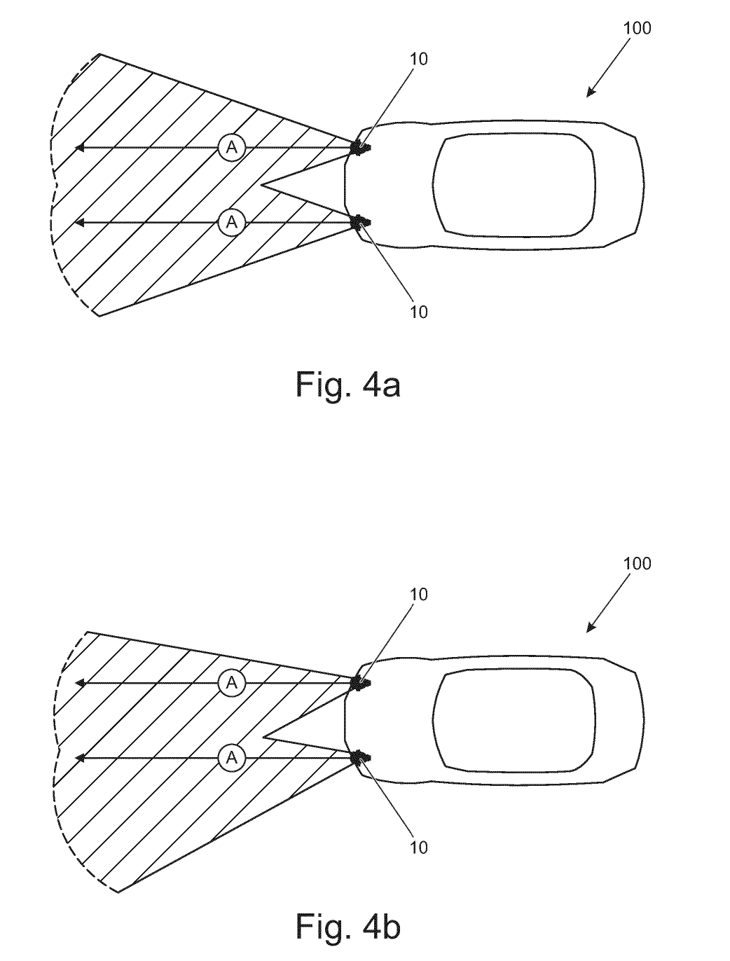

Similarity, FIGS. 4a and 4b illustrate example variations in horizontal spatial light distribution which may be formed by the illumination device 10. Specifically, FIG. 4a illustrates a substantially wide angle horizontal distribution of illuminating light which is cast in front of the vehicle 100. The horizontal distribution in FIG. 4a may correspond to a high beam distribution. This distribution may be formed, for example, by selectively operating all of the laser modules 12, as described above. Of course, it will be understood that in some embodiments one or more wide angle horizontal distributions may be formed by selectively operating one or more subsets of the laser modules 12.

FIG. 4b illustrates a substantially narrow angle horizontal distribution of illuminating light, at least narrower that the distribution illustrated in FIG. 4a. Further, the distribution is offset sideward, specifically leftward. Of course, in other embodiments the distribution of illuminating light may be offset rightward. The horizontal distribution in FIG. 4b may correspond to a low beam distribution. This distribution may be formed by selectively operating a subset of the laser modules 12, for example the laser modules 12 in a leftward portion of the device 10. Operating a subset of the modules 12 may irradiate one or more predetermined regions on a leftward half of the block 14 with laser light, thus the block may emit illuminating light radially in a leftward direction only. It will be understood that in some embodiments one or more narrow angle horizontal distributions and/or sideward distributions may be formed by selectively operating one or more subsets of the laser modules 12.

It will be understood that many spatial distributions of illuminating light cast in front of the vehicle 100 are possible. The spatial distributions of illuminating light correspond with many possible radial distributions of light emitted by the block 14. The exact number and shape of possible spatial distributions may vary in other embodiments depending on the number and arrangement of the laser modulus 12. Further, the shape of the possible spatial distributions may be affected by the shape of the reflecting surface 32 and/or the shape of the lens 40 and/or the shape of the fluorescent block 14.

The laser modules 12 may be selectively operated under the control of a control means in the form of a control unit, e.g. an Electronic Control Unit (“ECU”). An ECU is a conventional feature for monitoring and controlling various aspects of the vehicle 100. Accordingly, the function and means of operation of the ECU will not be described in detail. The laser modules 12 in combination with the ECU may form an illumination system provided within the vehicle 100. The ECU may perform a method of selectively operating one or more subsets of the lasers modules 12 to form one or more distributions of illuminating light in front of the vehicle 100. The method may comprise the ECU selectively operating one or more subsets of laser modules 12 to form one or more predetermined distributions of illuminating light in front of the vehicle 100. The predetermined distributions may, for example, correspond to high and low beam distributions. Alternatively, or in addition, the predetermined distributions may, for example, correspond to distributions suitable for left-hand traffic or right-hand traffic countries.

The modules 12 may be selectively operated under automated control of the ECU to alter the distribution of illuminating light, for example in response to changes in driving conditions, such as if the vehicle 100 transitions from suburban roads to motorways. By way of example, such a transition could be indicated by a change in the vehicle's 100 speed which is monitored by the ECU. In response to changes in driving conditions the ECU may cease selective operation of one or more subsets of laser modules 12 and initiate selective operation of one or more alternative subsets. In this manner the ECU may selectively control the laser modules 12 to alternate between one or more predetermined distributions of illuminating light, for example high beam and low beam distributions. Of course, the laser modules 12 may be operated, via the ECU, by manual controls operated by the vehicle's user.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. An illumination device for use as a vehicle headlight, the illumination device comprising:
at least one excitation light source configured to emit excitation light; and
a fluorescing material configured to receive at least a portion of the excitation light and to emit illuminating light in response thereto in an illumination direction of the illumination device,
wherein the at least one excitation light source is positioned substantially perpendicular to, or forward of, the fluorescing material in the illumination direction.

2. The illumination device of claim 1, wherein the at least one excitation light source comprises a radial array of two or more excitation light sources which are arranged to direct excitation light radially inward toward the fluorescing material, and/or wherein the illuminating light is emitted in the illumination direction through a central region of the radial array.

3. (canceled)

4. The illumination device of claim 1, further comprising a housing configured to support the at least one excitation light source in relation to the fluorescing material, optionally wherein the housing comprises an opening though which the illuminating light is directed in the illumination direction.

5. (canceled)

6. The illumination device of claim 4, wherein the housing comprises an annular portion, and wherein the radial array of two or more excitation light sources are arranged around the annular portion.

7-8. (canceled)

9. The illumination device of claim 1, wherein the at least one excitation light source is configured to emit the excitation light in a direction at least partly opposed to the illumination direction, and/or wherein the at least one excitation light source is positioned forward of the fluorescing material in the illumination direction at an angle within a range of 5° to 85° relative to the illumination direction.

10. (canceled)

11. The illumination device of claim 4, wherein the housing forms a channel having front and rear openings.

12. The illumination device of claim 11, wherein an axis of the channel substantially corresponds to the illumination direction, optionally wherein the illuminating light is directed toward the front opening of the housing.

13. (canceled)

14. The illumination device of claim 11, wherein at least one lens is positioned at the front opening of the housing.

15. The illumination device of claim 11, further comprising a reflective element attached to the rear opening of the housing.

16. The illumination device of claim 15, wherein the fluorescing material is positioned within the reflective element.

17. The illumination device of claim 1, further comprising a reflecting surface positioned to a rear of the fluorescing material and configured to direct the illuminating light in the illumination direction.

18. (canceled)

19. The illumination device of claim 11, wherein the housing is cylindrical and the front and rear openings are located at respective ends of the housing.

20. The illumination device of claim 1, wherein the at least one excitation light source is configured to irradiate one or more predetermined regions of the fluorescing material with the excitation light.

21. The illumination device of claim 4, wherein the housing is configured to provide a thermal conduit for the at least one excitation light source, optionally wherein the housing forms a heat sink for the at least one excitation light source.

22-25. (canceled)

26. An illumination device for use as a vehicle headlight, the illumination device comprising:
a plurality of excitation light sources configured to emit excitation light; and
a fluorescing material configured to receive at least a portion of the excitation light and to emit illuminating light in response thereto,
wherein the plurality of excitation light sources are spaced around the fluorescing material and each of the plurality of light sources is independently operable to control a distribution of the illuminating light emitted by the fluorescing material, optionally wherein each of the plurality of excitation light sources is configured to irradiate a respective region of the fluorescing material with the excitation light to thereby control the distribution of the illuminating light.

27. (canceled)

28. The illumination device of claim 26, wherein the plurality of excitation light sources are provided as a radial array of two or more excitation light sources which are configured to direct the excitation light radially inward toward the fluorescing material, optionally wherein the illuminating light is emitted in the illumination direction through a central region of the radial array.

29-30. (canceled)

31. An illumination system, comprising:
the illumination device of claim 26; and
a control unit configured to selectively cause at least some of the plurality of excitation light sources to emit excitation light toward the fluorescing material.

32. The system of claim 31, wherein the control unit is configured to:
selectively cause a first group of the plurality of excitation light sources to emit excitation light to form a first distribution of illuminating light; and
selectively cause a second group of the plurality of excitation light sources to emit excitation light to form a second distribution of illuminating light.

33. The illumination system of claim 32, wherein the first distribution of illuminating light is a dipped-beam pattern and the second distribution of illuminating light is a full-beam pattern, or wherein the first distribution of illuminating light is for use on a left-hand driving roadway pattern and the second distribution of illuminating light is for use on a right-hand driving roadway.

34-39. (canceled)

40. A vehicle comprising the illumination device of claim 1.

41. (canceled)
